(19) United States
(12) Patent Application Publication
(10) Pub. No.: US 2018/0316768 A1
(43) Pub. Date: Nov. 1, 2018

(54) SHARING DEVICE CAPABILITIES BETWEEN DEVICES

(71) Applicant: Google Inc., Mountain View, CA (US)

(72) Inventors: Benjamin GOLDSMITH, San Francisco, CA (US); Tiantian Zha, Mountain View, CA (US); Jennifer Shien-Ming Chen, San Francisco, CA (US); Alexander Friedrich Kuscher, San Francisco, CA (US); Santhosh Balasubramanian, Sunnyvale, CA (US)

(21) Appl. No.: 14/839,846

(22) Filed: Aug. 28, 2015

(51) Int. Cl. H04L 29/08

(52) U.S. Cl. CPC H04L 67/16; H04L 67/327; H04L 67/18

(57) ABSTRACT

A system and method is disclosed for sharing device capabilities between computing devices. A plurality of device capabilities are registered with a server. A first computing device, on identifying an operation to be performed by an application on the first computing device, accesses the server and determines one of the registered device capabilities to perform the operation. The operation is then reassigned from the first computing device to the second computing device based on the determination of the device capability. The operation is performed by the second computing device and the result of the operation provided to the first computing device.

### TECHNICAL FIELD

The subject technology relates generally to sharing device capabilities.

### BACKGROUND

A user may have access to multiple devices. Each device may have different device capabilities and/or may be used for different types of operations. For example, the user may take pictures using a smartphone and then edit the pictures using a laptop. The photos may then be transferred to a different device to be shared with other users, e.g., by manually uploading the pictures to the other device.

### SUMMARY

The subject technology provides a system and computer-implemented method for sharing device capabilities between computing devices. In one or more implementations, a computer-implemented method comprises identifying, without user intervention, an operation to be performed by a software application executed by a first computing device, identifying, by the first computing device, a plurality of device capabilities of one or more second computing devices, in response to identifying the operation and without user intervention, determining one of the identified device capabilities to perform the operation, reassigning performance of the operation from the first computing device to a respective computing device associated with the determined device capability, and receiving, by the first computing device, a result of the operation from the respective computing device. Other aspects include corresponding systems, apparatuses, and computer program products for implementation of the computer-implemented method.

In one or more implementations, a machine-readable media stores instructions thereon that, when executed by a machine or computer, cause the machine or computer to identify, without user intervention, an operation to be performed by a software application on a first computing device, identify, for the first computing device, a plurality of device capabilities of one or more second computing devices, in response to identifying the operation and without user intervention, determined one of the identified device capabilities to perform the operation, reassign performance of the operation from the first computing device to a respective computing device associated with the determined device capability, and receive, by the first computing device, a result of the operation from the respective computing device. Other aspects include corresponding apparatuses, methods, systems, and computer program products for implementation of the foregoing machine-readable media.

In one or more implementations, a system comprises one or more processors, and a memory media having instructions stored thereon. When executed, the instructions cause the one or more processors to identify a plurality of device capabilities of a plurality of computing devices, identify, without user intervention, an operation to be performed by a software application on a first computing device, in response to identifying the operation, determine from the identified device capabilities a device capability of a second computing device to perform the operation, reassign performance of the operation from the first computing device to a second computing device based on the determined device capability, the determined device capability facilitating performance of the device capability at the second computing device, and receive a result of the operation from the second computing device. Other aspects include corresponding apparatuses, methods, and computer program products for implementation of the foregoing system.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

A detailed description will be made with reference to the accompanying drawings:

FIG. 1 is a diagram of an example system for sharing device capabilities between computing devices.

FIG. 2 depicts example components and data flow for registering example device capabilities with an example user account.

FIG. 3 depicts example components and data flow for sharing device capabilities between computing devices.

FIG. 4 depicts a flow diagram of an example process for sharing device capabilities between computing devices.

FIG. 5 is a diagram depicting an example electronic system for sharing device capabilities between computing devices.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The subject technology enhances performance of computing devices associated with a user account by aggregating device capabilities of the devices and sharing the capabilities between the devices. In this regard, each device may register its hardware and/or software capabilities with a user account associated with the devices. The user account stores the aggregation of capabilities for all devices, and the aggregated capability information is provided to a device when the device is authenticated to the user account.

When a user's computing device accesses (e.g., authenticates to) the user's user account a plurality of device capabilities of each device associated with the user account are identified and then registered with the computing device. The subject technology, when installed on the computing device, may identify, without user intervention, operations initiated by software applications on the computing device, and determine whether an operation may be performed (e.g., more efficiently) using one or more of the registered device capabilities. If one or more of the registered device capabilities of a different, remote computing device is determined to be capable of enhancing the performance of the operation or the application responsible for the operation by performance of the operation then the operation may be automatically assigned to the remote computing device for performance of the operation. Operation data and any associated parameters for the operation are then transferred to the remote computing device for performance of the operation on the remote device.

Transfer of an operation between devices may be brokered by agent applications on the devices. For example, an agent application on the remote computing device may act as a proxy for the operation data transferred from a proxy on a local computing device. In this manner, the remote computing device receives the operation data (e.g., via the agent proxies) without user intervention and performs the operation as if the operation originated from an application on the remote computing device. The result of the operation is then transferred (e.g., via the proxy agents) back to the local device. The local device may then provide the result to the original application or user as if the operation was performed completely on the local device.

Determining which of the registered hardware features and/or which device should perform an operation may depend on the type of operation and various other factors. Types of operations may include video editing, video and/or audio recording, location detection, and internet connectivity, and factors for making the determination may include, e.g., available bandwidth of the devices, processing power (speed), location of the devices, storage size, signal strength of a connection, etc. The transfer of operation data from a local computing device to a remote computing device may be accomplished (e.g., through the agent proxies) via an upload/download to/from a server, through a local area network (e.g., via WiFi), or via a Bluetooth connection directly between the devices.

In one example implementation, a first user may initiate a video conference with a second user using the a first computing device. The first computing device may, on detecting the initiation of the video conference, identify an application requirement for input audio-visual streams. The first computing device may then determine one or more of a plurality of registered device capabilities to receive the input audio-visual streams. A determination as to which registered capability should be used may be based on the location of devices (e.g., relative to the first device) that have the ability to receive audio visual information, their respective stream resolutions, and/or device bandwidths. Once a device capability is identified, the operation of receiving or recording the audio video stream may be assigned to the computing device having the registered capability. For example, a microphone of a smartphone in the proximity to the first computing device conducting the video conference may be switched on for use as a primary or auxiliary microphone. Likewise, the user may be provided the option to use a camera of the smartphone as an auxiliary camera.

In one or more implementations, if the use of an auxiliary device capability would implicate a privacy issue then the subject technology may alert the user that the hardware feature is being used. For example, a notification may be displayed on the first computing device, or the first or second computing device may vibrate, to alert the user of the use of the hardware implicating privacy on the secondary device.

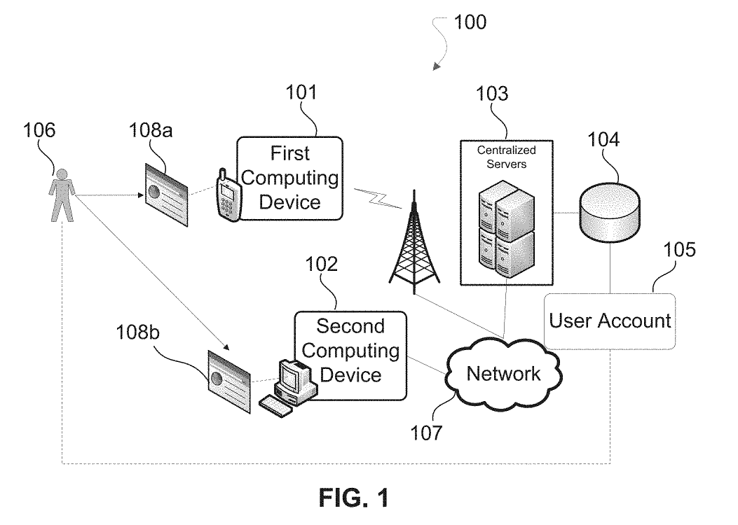

FIG. 1 is a diagram of an example system 100 for sharing device capabilities between computing devices, according to one or more aspects of the subject technology. A system 100 may include one or more computing devices 101, 102 (e.g., a smartphone, tablet or notebook computer, personal computer, PDA, or the like), one or more centralized servers 103, and a remote storage 104 (e.g., a database).

According to various implementations, computing devices 101 and 102 may be tied to a user account 105. Accordingly, a user 106 is authorized to use certain features of a respective device 101, 102 by authenticating to user account 105. Additionally, as will be described further, each device 101, 102 may be authorized to use certain hardware and/or software features of the other device(s) by authenticating to user account 105.

User account 105 may be, e.g., a cloud-based or web-based user account or may be an enterprise account (e.g., LDAP account), and may function as a universal account for multiple devices. In this regard, information stored in connection with the user account may be centrally located on a third computing device, e.g., on a server 103 (e.g., in a “data cloud”). Server 103 may be operably connected to, e.g., first and second computing devices 101, 102 over a network 107 (e.g., a LAN, WAN, WiFi, cellular network, or the Internet). Remote storage 104 may store information in connection with user account 105. The functionality of server 103 and remote storage 104 may be implemented on the same physical server or distributed among a plurality of servers. Moreover, remote storage 104 may take any form such as relational databases, object-oriented databases, file structures, text-based records, or other forms of data repositories.

The various connections between computing devices 101 and 102, server 103, and storage 104 may be made over a wired or wireless connection. Computing devices 101 and 102 may be co-located within a defined area. For example, the devices may be connected to the same LAN or WiFi network. Computing devices 101 and 102 may be in different locations such as at the user's home and place of employment. According to various aspects, computing devices 101 and 102 may be configured to load and execute one or more user interfaces 108a, 108b for interaction with one or more software applications, including web-applications provided by, e.g., server 103. A user interface 108 may include an interface provided by a desktop or mobile operating system, or an interface provided by a stand-alone application (e.g., a web-browser or web-enabled application) executing on the device and managed by the operating system. As will be discussed further, the user interface of each device may be used to receive, display, and manage device capabilities provided to or by devices linked to user account 105.

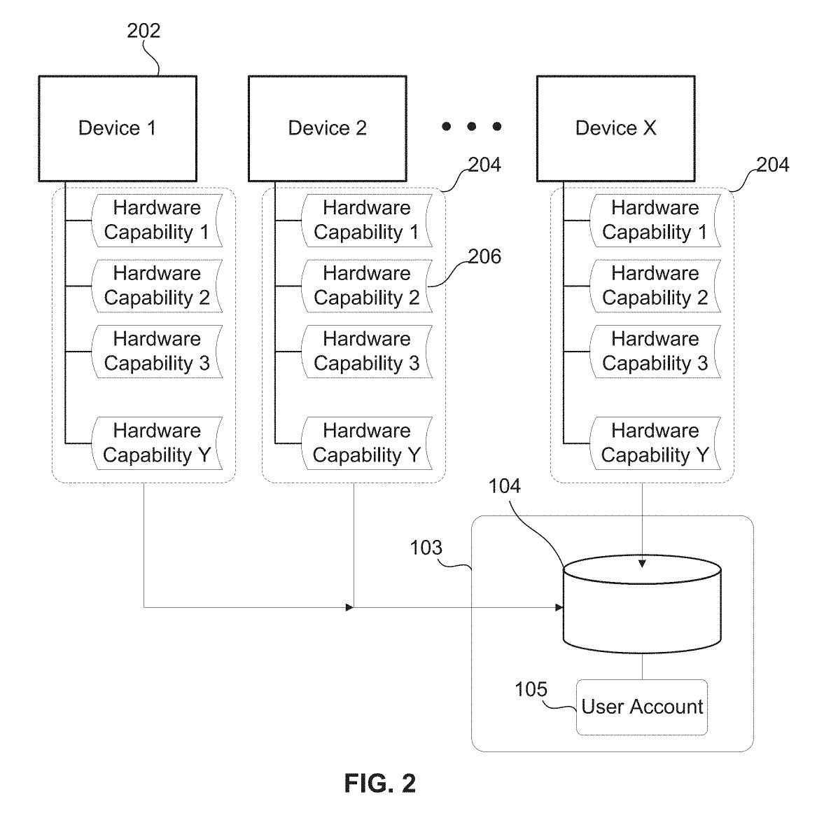

FIG. 2 depicts example components and data flow for registering example device capabilities with an example user account, according to one or more aspects of the subject technology. In the depicted example, a plurality of devices 1 to X (including, e.g., devices 101, 102) each register a device group 204 of device capabilities 1 to Y 206 with server 103. Each device capability 206 may be a hardware or software capability of a device. Example capabilities may include, e.g., the ability to record audio and/or video, process recorded audio and/or video, render graphics (e.g., 2D or 3D), provide location sensing (e.g., GPS), provide WiFi access or access to a network (e.g., via an access point), provide motion sensing (e.g., use of an accelerometer, altimeter, or gyroscope), store data (e.g., on a hard disk or removable media), etc.

Device capabilities 206 are associated with user account 105 in remote storage 104 and associated (e.g., indexed) with their respective devices. In this regard, any of devices 202, when authorized by user account 105, may discover the device capabilities registered with user account 105. Each device capability 206 may be registered with meta information about the capability. For example, the meta information may include whether the capability is hardware or software-related, the name of the capability, an identifier for the capability, applications associated with the capability, types of information that may be processed by the capability, etc. In one or more implementations, each group 204 of device capabilities 206 may registered and accessed as a “bundle” of hardware or software capabilities provided by a respective device to which they are associated.

With reference to FIG. 1, user interface 108 may provide a settings screen for selecting device capabilities 206 of a device 101, 102, or device group(s) 204, for registration with user account 105. The settings screen may be a web application, or part of an application. For example, the settings screen may be provided by a web server (e.g., server 103) and displayed in a web browser on device 101, 102. The settings screen may also be integrated into an operating system (e.g., a mobile operating system) and displayed from a settings or control panel of the operating system. A user may be required to be authenticated and/or authorized by user account 105 before having the ability to connect to server 103 and/or register device capabilities with user account 105.

A user of each device 101, 102 may use the setting screen to select which device capabilities 206 of other devices, or device group(s) 204, should be used by device 101 and/or which capabilities of device 101 are to be made available to other devices via user account 105. For example, a user may specifically select to allow other devices to process audio or video information received at device 101 but to not allow other devices to record audio or video for device 101.

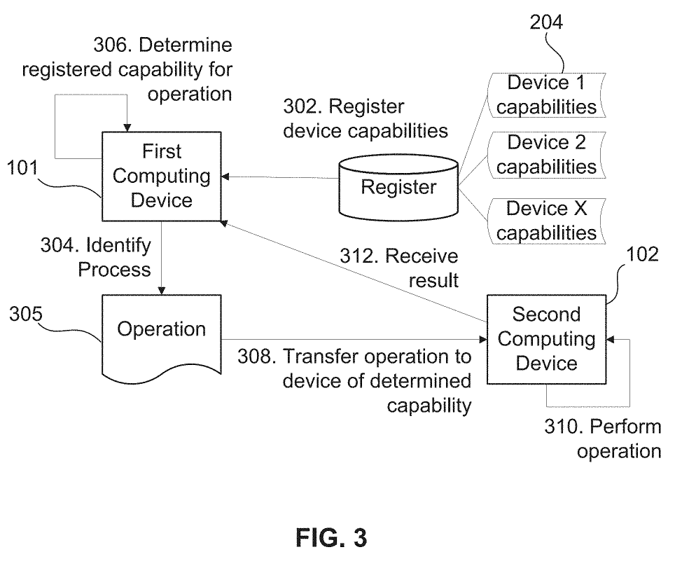

FIG. 3 depicts example components and data flow for sharing device capabilities between computing devices, according to one aspect of the subject technology. In the depicted example, each device 101, 102 linked to user account 105 registers 302 a group 204 of one or more device capabilities 206, or device group(s) 204, with user account 105, and the device capabilities 206 are stored and indexed in remote storage 105 in connection with user account 105 and made available to account linked devices. A device 101 then may access user account 105 to determine device capabilities 206, or device group(s) 204, that are available to device 101 by way of the subject technology. A device having multiple registered capabilities 206 may act as a master device, aggregating (e.g., in a device bundle) capabilities of a plurality of devices.

Device 101 includes software and/or firmware instructions that automatically (e.g., without user intervention) identify an operation 305 to be performed by a software application (304). For example, operation 305 may be identified when a library is called to perform operation 305, or when a signature or meta data for the operation is identified (e.g., recognized) on a data bus associated with a processor responsible for processing at least a portion of operation 305. In one or more implementations, software or hardware of device 101 may be configured to identify a predetermined set of operations, e.g., for a predetermined set of applications. In one or more implementations, operations are defined based on a specific type of operation. For example, the software or firmware may be configured to identify an audio or video operation by way of a signature or meta data of audio or video data received on a bus or by way of the audio or video data being sent to hardware or software dedicated to processing audio or video data.

In the depicted example, when a predetermined operation 305 is identified, device 101 determines whether a registered device capability 206 on a different device should handle processing of operation 305 (306). Device 101 may determine available device capabilities 206 in various ways. In one or more implementations, device capabilities 206, or device group(s) 204, may be registered locally at device 101 using the previously described settings screen. In one or more implementations, device 101 may access user account 105 on execution of an application, and determine what device capabilities 206 are registered with user account 105 that are, e.g., compatible with the application. In one or more implementations, device 101 may access user account 105 to determine whether a device capability is available when an operation meeting certain criteria is initiated. The criteria may include, e.g., the operation being of a type that would require more than a threshold amount of processing power. For Example, an operation involving recording and/or rendering videos or photos may be flagged as a candidate operation to be handled externally by another device. Additionally or in the alternative, the processing power of devices having the same capability may be compared and the capability of the device estimated to perform the operation most efficiently selected. In this manner, device 102 may facilitate faster rendering in 3D modeling applications initiated on device 101.

Once operation 305 and a registered device capability 206 is determined, operation 305 is transferred to the device 102 associated with the determined device capability 206 (308). The device may be transferred from device 101 to device 102 over an existing network connection between the devices. In this regard, operational data required to perform operation 305 is packaged in network packets by device 101 and sent to device 102. The operational data may be sent as an object including, e.g., state of the application at device 101, settings for the application, and application data. The operational data may be sent to, e.g., server 103 and server 103 may send the data to device 102. The operational data may be sent directly between the devices if a path for network communication exists (e.g., connected via a LAN, Internet, WiFi, Bluetooth, etc.)

Device 102 receives operation 305, including or represented by the transferred operational data, and performs operation 305 using resources available to device 102 (310). For example, device 102 may receive a state object, together with an identification of an application or hardware on device 102 for performing operation 305, and provide the state object to the application or hardware for processing. Once operation 305 has been processed, device 102 provides the result 310 of operation 305 back to device 101 (312). In this regard, result data may be transferred from device 101 to device 102 over the existing network connection between the devices. The result data may be packaged in network packets by device 102 and sent to device 101.

In one or more implementations, determination of the most suitable device capability 206 for performance of operation 305 may be performed by server 103. For example, server 103 may receive information about an operation to be performed by a software application executed by device 101. Server 103 may then identify a plurality of device capabilities 206 registered with user account 105, and based on the received information, select one of the identified device capabilities 206 for performance of operation 305. Server 103 may determine that operation 305 be moved to a different device or remain at the originating device. Server 103 may make the selection based on meta data associated with each device capability, which may include information about the respective device hosting the device capability. For example, the determination as to which device 101, 102 performs operation 305 and with what device capability may be determined based on processing speed of the respective devices, estimated time to transfer operation 305 between the devices, memory capabilities, bandwidth based on operations currently running on the devices, etc.

Server 103 may then receive operational data required to perform operation 305 from the device 101 and provide the operational data to device 102. Server 103 may then receive the result of operation 305 from device 102 and send the result to device 101.

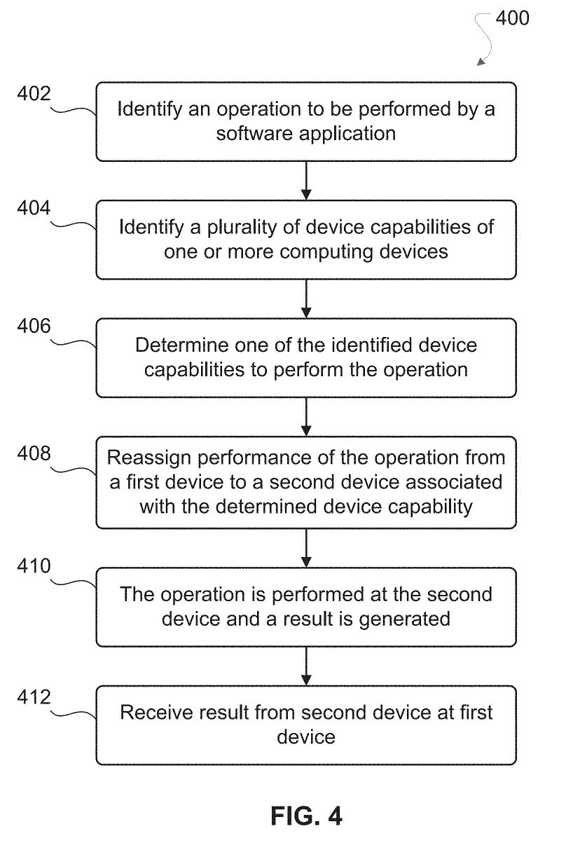

FIG. 4 depicts a flow diagram of an example process 400 for transferring notifications between multiple computing devices, according to aspects of the subject technology. For explanatory purposes, example process 400 is described herein with reference to the components of FIG. 1, FIG. 2, and FIG. 3. Further for explanatory purposes, the blocks of example process 400 are described herein as occurring in serial, or linearly. However, multiple blocks of example process 400 may occur in parallel. In addition, the blocks of example process 400 need not be performed in the order shown and/or one or more of the blocks of example process 400 need not be performed.

In the depicted example flow diagram, computing device 101 identifies an operation 305 to be performed by a software application executed by a first computing device (402). Operation 305 may be identified based on the software or hardware which is responsible for generating and/or processing the operation being registered with device 101 (or server 103), e.g., using the previously described settings screen. Additionally or in the alternative, operation 305 may be identified based on matching a signature or meta data of the operation to predetermined signatures or meta data. In one or more implementations, the operation 305 may be identified to be performed by hardware of device 101 (e.g., by a graphics processor).

The computing device 101 also identifies a plurality of device capabilities 206 of one or more second computing devices 102 (404). Additionally or in the alternative, device capabilities 206 may be identified by server 103. Device capabilities 206 may be identified before or after operation 305 is identified. In this regard, device capabilities 206 may be identified as part of a registration process by which the capabilities are registered with user account 105 and stored in, e.g., remote storage 104. For example, device capabilities 206 may be stored in connection with user account 105 and indexed by each respective device to which they are associated. Device capabilities 206 may then be identified when device 101 accesses user account 105, e.g., by accessing server 103. Additionally or in the alternative, device capabilities 206 of other devices (e.g., device 102) may be registered by device 101 and indexed in a local storage on device 101.

In response to identifying operation 305, computing device 101 and/or server 103 determines one of the identified device capabilities to perform the operation (406). In various aspects, the determined device capability 206 is determined from the previously registered device capabilities 206 associated with user account 105 (e.g., locally or at server 103).

In one or more implementations, a device capability 206 for performing operation 305 is determined based on a type of the operation and an ability of the respective computing device associated with the capability to perform the type of operation more efficiently than device 101. For example, operation 305 initiated at device 101 may be a video operation, and device 102 may be identified as having more processing power for processing video-related operations. In this regard, device 102 may be selected to perform the operation. In another example, device 102, by sharing a camera as a device capability 206, may enable the camera to act as an auxiliary or second camera during a video conference conducted by a user using device 101. For example, the camera of a smartphone may be enabled to provide a different perspective than the camera in device 101.

In one or more implementations, a device capability 206 for performing operation 305 is determined based on a location, relative to device 101, of the computing devices associated with registered capabilities. For example, each device 101, 102 may periodically report its geographic location (e.g., using a geographic positioning system (GPS)) to user account 105 and a determination of the device capability for performing operation 305 may include querying user account 105 to identify devices that are within a predetermined range of device 101. Devices may be determined to be within the predetermined range if they are, e.g., connected to the same WiFi network. The devices may also report other data indicative of their position and/or orientation using sensors integrated within the devices. For example, gyroscope, altimeter, and accelerometer data may also be used to determine position and/or orientation. In this manner, audio and video recording capabilities, e.g., in a camera integrated with a mobile device, may be determined to be able to capture audio or video for device 101 from the same area but using a different perspective than, but complementary to, a camera integrated with device 101.

Once device capability 206 at device 102 is determined, performance of operation 305 is reassigned from device 101 to device 102 (408). As described previously, the operation may be reassigned by transferring operational data required to perform the operation from device 101 to device 102 over a network. In one or more implementations, device 101 may be configured with a proxy application integrated with one or more applications on the device and/or with device hardware. Selection of the applications and/or hardware may be made, e.g., through the previously described settings screen. The proxy may receive the operational data for operation 305 and provide the data to a complementary proxy associated with device 102. Parameters for transferring data between the proxies (e.g., network address, ports, etc.) may be provided through user account 105. When the operation has been performed at device 102 the proxy may receive the result from the proxy at device 102.

In one or more implementations, two or more operations of the same type may be generated at device 101 based on an activated state of a software application. For example, the operations may both be audio or video-related operations. Accordingly, device 101 (or server 103) may determine that only one of the operations is to be reassigned to a different device. In some aspects, one or both operations may be assigned to a different device or both operations may be reassigned to multiple different devices. As described previously, one example may include the use of devices in a video conference. Each operation may include capturing audio and/or video, and one of the operations is reassigned to a different device to capture audio and/or video from a different perspective.

In one or more implementations, device 101 (or server 103) may determine that performance of the operation by the respective computing device implicates a privacy issue of a user associated with device 101 and, in response to determining that the performance implicates the privacy issue, provide an alert by the first computing device before performance of the operation is reassigned. Accordingly, device 102 (e.g., a smartphone) could be buzzed or an alert customized to the type of privacy issue or device capability to be used may be displayed on one or more of the devices 101, 102. Once such example, may include capturing audio or video from a device different than the device upon which an audio and/or video conference is initiated.

After operation 305 is reassigned to device 102, the operation is performed and a result of the operation is generated (410). Device 102 may be configured with a proxy application that receives the operational data for the operation and provides the data to complementary software or hardware on device 102 for performing the operation. When the operation has been performed the proxy may receive or intercept the result. The result of the operation is then received by computing device 101 from the respective computing device 102 (412). The result of the operation may be received in the same way it is transmitted, e.g., over the same network in which it was transmitted. The result of the operation may be provided to user account 105, and device 101 may retrieve the result from user account 101.

Many of the features in the above-described example process 400, and related applications, may be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media, by itself, does not include carrier waves and electronic signals passing wirelessly or over wired connections.

The term “software” is meant to include, where appropriate, firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

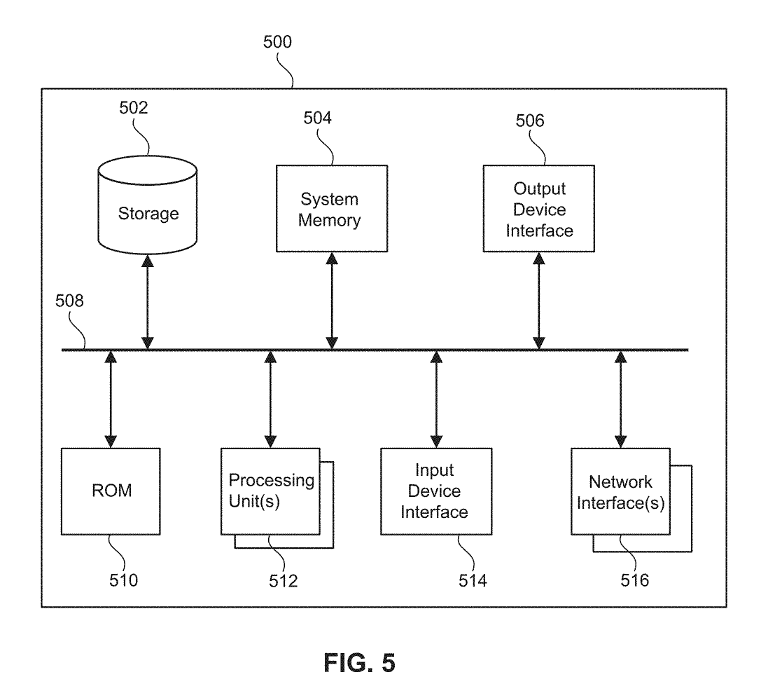

FIG. 5 is a diagram illustrating an example electronic system 500 for use in connection with transferring notifications between multiple computing devices, according to one or more aspects of the subject technology. Electronic system 500 may be a computing device for execution of software associated with the operation of computing device 100, or one or more portions or steps of process 400, or components and processes provided by FIGS. 1-4. In various implementations, electronic system 500 may be representative of first or second computing device 101, 102, or server 103. In this regard, electronic system 500 may be a personal computer or a mobile device such as a tablet computer, laptop, smartphone, PDA, or other touch screen or television with one or more processors embedded therein or coupled thereto, or any other sort of computer-related electronic device having wireless connectivity.

Electronic system 500 may include various types of computer readable media and interfaces for various other types of computer readable media. In the depicted example, electronic system 500 includes a bus 508, processing unit(s) 512, a system memory 504, a read-only memory (ROM) 510, a permanent storage device 502, an input device interface 514, an output device interface 506, and one or more network interfaces 516. In some implementations, electronic system 500 may include or be integrated with other computing devices or circuitry for operation of the various components and processes previously described.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, e.g., alphanumeric keyboards and pointing devices (also called “cursor control devices”). Output device interfaces 506 enables, e.g., the display of images generated by the electronic system 500. Output devices used with output device interface 506 include, e.g., printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through network interfaces 516. Network interfaces 516 may include, e.g., a wireless access point (e.g., Bluetooth or WiFi) or radio circuitry for connecting to a wireless access point. Network interfaces 516 may also include hardware (e.g., Ethernet hardware) for connecting the computer to a part of a network of computers such as a local area network (“LAN”), a wide area network (“WAN”), wireless LAN, or an Intranet, or a network of networks, such as the Internet. Any or all components of electronic system 500 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user, e.g., by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The term website, as used herein, may include any aspect of a website, including one or more web pages, one or more servers used to host or store web related content, and the like. Accordingly, the term website may be used interchangeably with the terms web page and server. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

1. A computer-implemented method, comprising:
receiving, at a server, a plurality of device capabilities of a plurality of computing devices remote from the server;
associating, at the server, the received plurality of device capabilities with a user account;
identifying, by the server, an operation to be performed by a software application executed by a first computing device of the plurality of computing devices, based on the first computing device being authenticated to the user account;
in response to identifying the operation, selecting, by the server based on a location relative to the first computing device of one or more other computing devices of the plurality of computing devices, which one of the plurality of device capabilities associated with the user account to perform the operation;
reassigning, by the server, performance of the operation from the first computing device to a respective second computing device associated with the selected device capability, including receiving operational data for performing the operation from the first computing device, and providing the operational data from the server to the respective second computing device; and
receiving, by the server, a result of the operation from the respective second computing device, and providing the result to the first computing device.

2. (canceled)

3. (canceled)

4. (canceled)

5. The computer-implemented method of claim 1, wherein reassigning performance of the operation comprises:
transferring the operational data from the first computing device to the respective second computing device over a network,
wherein the result of the operation is received over the network.

6. The computer-implemented method of claim 1, further comprising:
generating two or more operations of a same type based on an activated state of the software application, wherein the operation reassigned to the respective second computing device is one of the two or more operations of the same type.

7. The computer-implemented method of claim 6, wherein the two or more operations of the same type comprise audio or visual recording.

8. The computer-implemented method of claim 1, wherein the selected device capability is selected based on a type of the operation and an ability of the respective second computing device to perform the type of the operation more efficiently than the first computing device.

9. (canceled)

10. The computer-implemented method of claim 1, further comprising:
determining that performance of the operation by the respective second computing device implicates a privacy issue of a user associated with the first computing device; and
in response to determining that the performance implicates the privacy issue, providing an alert by the first computing device before performance of the operation is reassigned.

11. A machine-readable medium storing instructions thereon that, when executed by a machine or computer, cause the machine or computer to:
receive, at a server, device capabilities of a plurality of computing devices remote from the server;
associate, at the server, the received device capabilities with a user account;
identify, by the server, an operation to be performed by a software application on a first computing device of the plurality of computing devices, based on the first computing device being authenticated to the user account;
in response to identifying the operation, select, by the server based on a location relative to the first computing device of one or more other computing devices of the plurality of computing devices, which one of the device capabilities associated with the user account to perform the operation;
reassign, by the server, performance of the operation from the first computing device to a respective second computing device associated with the selected device capability, including receiving operational data for performing the operation from the first computing device, and provide the operational data from the server to the respective second computing device; and
receive, by the server, a result of the operation from the respective second computing device, and provide the result to the first computing device.

12. The machine-readable medium of claim 11, wherein the instructions, when executed by the machine or computer, further cause the machine or computer to:
access, by the first computing device, a server remote from the first computing device to identify the device capabilities of the one or more second computing devices, wherein the device capabilities are stored in connection with a user account and each of the second computing devices are linked to the user account.

13. (canceled)

14. The machine-readable medium of claim 11, wherein the instructions, when executed by the machine or computer, further cause the machine or computer to:
generate two or more operations of a same type based on an activated state of the software application, wherein the operation reassigned to the respective second computing device is one of the two or more operations of the same type.

15. The machine-readable medium of claim 14, wherein the two or more operations of the same type comprise audio or visual recording.

16. The machine-readable medium of claim 11, wherein the selected device capability is selected based on a type of the operation and an ability of the respective second computing device to perform the type of the operation more efficiently than the first computing device.

17. The machine-readable medium of claim 11, wherein the determined device capability is determined based on a location of the one or more second computing devices relative to the first computing device.

18. The machine-readable medium of claim 11, wherein the instructions, when executed by the machine or computer, further cause the machine or computer to:
determine that performance of the operation by the respective second computing device implicates a privacy issue of a user associated with the first computing device; and
in response to determining that the performance implicates the privacy issue, provide an alert by the first computing device before performance of the operation is reassigned.

19. A system, comprising:
one or more processors; and
a memory media, having instructions stored thereon that, when executed, cause the one or more processors to:
receive device capabilities of a plurality of computing devices remote from the system;
associate the received device capabilities with a user account;
identify an operation to be performed by a software application on a first computing device of the plurality of computing devices, based on the first computing device being authenticated to the user account;
in response to identifying the operation, select, from the device capabilities associated with the user account, a selected device capability of a second computing device to perform the operation based on a location relative to the first computing device of the second computing device and one or more other computing devices of the plurality of computing devices;
reassign performance of the operation from the first computing device to a second computing device based on the selected device capability, the determined device capability facilitating performance of the device capability at the second computing device;
receive operational data for performing the operation from the first computing device;
provide the operational data to the second computing device;
receive a result of the operation from the second computing device; and
provide the result to the first computing device.

20. The system of claim 19, wherein the instructions, when executed, further cause the one or more processors to:
determine the device capabilities based on authentication to the user account,
wherein each of the device capabilities is registered with the user account by a respective one of the plurality of computing devices.
